(19) United States
(12) Patent Application Publication
(10) Pub. No.: US 2020/0234291 A1
(43) Pub. Date: Jul. 23, 2020

(54) METHOD AND SYSTEM FOR PURCHASE AGREEMENT PROCESSING

(71) Applicant: ALIBABA GROUP HOLDING LIMITED, GRAND CAYMAN (KY)

(72) Inventor: Yijin GAO, HANGZHOU (CN)

(21) Appl. No.: 16/821,836

(22) Filed: Mar. 17, 2020

Related U.S. Application Data
(63) Continuation of application No. PCT/CN2020/071465, filed on Jan. 10, 2020.

(30) Foreign Application Priority Data
Apr. 28, 2019 (CN) 201910350166.9

(51) Int. Cl. G06Q 20/38; G06Q 20/40; H04L 9/06

(52) U.S. Cl. CPC G06Q 20/388; G06Q 20/407; H04L 9/0637; G06Q 20/405

(57) ABSTRACT

A method of a purchase agreement processing includes a first terminal associated with a first account. The first terminal may acquire a purchase agreement element packet released by a merchant system. The first terminal may sign a purchase agreement with the merchant system based on the purchase agreement element packet, and enable the first account to join a blockchain. The first terminal may send an invitation message to other terminals for at least one other account to join the blockchain according to the invitation message, and storing purchase records of the first account and the at least one other account in the blockchain for determining, according to the purchase records in the blockchain, performance of the purchase agreement.

### CROSS-REFERENCE TO RELATED APPLICATIONS

This application is a continuation application of International Patent Application No. PCT/CN2020/071465 filed on Jan. 10, 2020, which claims priority to and benefits of the Chinese Patent Application No. 201910350166.9, filed on Apr. 28, 2019. The contents of the above-referenced applications are incorporated herein by reference in their entirety.

### TECHNICAL FIELD

The present application relates to the technical field of computers.

### BACKGROUND

A credit purchase agreement is a technical solution that uses a user's credit as guaranty. The credit purchase agreement collects the user's original credit behaviors through a computer system to form a set of credit value standards. The set of credit value standards is used as a bond or collateral to replace currency, negotiable security or objects to establish a purchase agreement with a merchant.

By using the user's credit as guaranty, a credit standard value can replace universal equivalents such as currencies and negotiable securities in some primary fields to act as a bond or collateral (e.g., a monetized pre-deposit in common business conducts or a prepaid mode, such as member card used in a barber shop).

During the process of forming a purchase agreement between a user and a merchant, the matching efficiency is low, and there may be situations where it is difficult for individual users to complete rights and interests provided by the merchant, and the resources are oversupplied.

### SUMMARY OF THE INVENTION

The specification provides a purchase agreement processing method and the system thereof, to improve the efficiency of matching between a merchant and a user involved in the purchase agreement, and the efficiency of propagation of the purchase agreement element packet.

The present application discloses a purchase agreement processing method, which comprises: acquiring, by a first terminal associated with a first account, a purchase agreement element packet released by a merchant system; signing, based on the purchase agreement element packet, a purchase agreement between the first terminal and the merchant system; enabling, by the first terminal, the first account to join a blockchain; sending, from the first terminal, an invitation message to other terminals for at least one other account to join the blockchain according to the invitation message; storing purchase records of the first account and the at least one other account in the blockchain for determining, according to the purchase records in the blockchain, performance of the purchase agreement.

In an embodiment, the signing, based on the purchase agreement element packet, a purchase agreement between the first terminal and the merchant system comprises: querying, by the merchant system, a credit standard value of the first account; signing, if the credit standard value satisfies agreed terms, the purchase agreement by the merchant system with the first terminal, and rejecting, if the credit standard value does not satisfy the agree terms, the first terminal.

In an embodiment, the credit standard value of the first account is used as a guaranty when the purchase agreement is signed.

In an embodiment, the blockchain is a private blockchain.

In an embodiment, the purchase records of the first account and the at least one other account are recorded in a distributed ledger in the blockchain, and the merchant system, the first terminal and the terminals of the at least one other account are configured to query data in the blockchain.

In an embodiment, information of the purchase agreement element packet and the first account is recorded in a first block of the blockchain.

In an embodiment, the determining, according to the purchase records in the blockchain, performance of the purchase agreement further comprises: generating statistics for the purchase records in the blockchain; if the statistics satisfies requirements in the purchase agreement, determining that the purchase agreement is performed, and if the statistics fails to satisfy the requirements in the purchase agreement, determining that there is a breach of the purchase agreement.

In an embodiment, the method further comprises increasing, in response to determining that the purchase agreement is performed, the credit standard value of the first account.

In an embodiment, the method further comprises refunding, in response to determining that there is a breach of the purchase agreement, agreed rights and interests to the merchant system from the first account. In an embodiment, the method further comprises reducing, in response to determining that there is a breach of the purchase agreement, the credit standard value of the first account if the first account fails to refund the agreed rights and interests to the merchant system within an agreed time limit.

The present application further discloses a purchase agreement processing system, which comprises: one or more processors, and a memory storing instructions that, when executed by the one or more processors, cause the system to perform: acquiring, by a first terminal associated with a first account, a purchase agreement element packet released by a merchant system; signing, based on the purchase agreement element packet, a purchase agreement between the first terminal and the merchant system; enabling, by the first terminal, the first account to join a blockchain; sending, from the first terminal, an invitation message to other terminals for at least one other account to join the blockchain according to the invitation message; and storing purchase records of the first account and the at least one other account in the blockchain for determining, according to the purchase records in the blockchain, performance of the purchase agreement.

In an embodiment, the merchant system is configured to query a credit standard value of the first account; determine whether the credit standard value satisfies the agreed terms; and sign the purchase agreement with the first terminal in response to determining that the credit standard value satisfies the agreed terms.

In an embodiment, the credit standard value of the first account is used as a guaranty when the purchase agreement is signed.

In an embodiment, the blockchain is a private blockchain.

In an embodiment, the purchase records of the first account and the at least one other account are recorded in a distributed ledger in the blockchain, and the merchant system, the first terminal and terminals of the at least one other accounts is configured to query data in the blockchain.

In an embodiment, information of the purchase agreement element packet and the first account is recorded in a first block of the blockchain.

In an embodiment, the determining, according to the purchase records in the blockchain, performance of the purchase agreement comprises: generating statistics for the purchase records in the blockchain, determining that the purchase agreement is performed if the statistic satisfies the requirements in the purchase agreement, and determining that there is a breach of the purchase agreement if the statistics fails to satisfy the requirements in the purchase agreement.

In an embodiment, the determining, according to the purchase records in the blockchain, performance of the purchase agreement comprises: increasing, in response to determining that the agreement is performed, the credit standard value of the first account.

In an embodiment, the system is further configured to refund, in response to determining that there is a breach of the purchase agreement, agreed rights and interests to the merchant system.

In an embodiment, the system is further configured to reduce the credit standard value of the first account if the first account fails to refund the agreed rights and interests to the merchant system within an agreed time limit.

The present application further discloses a non-transitory computer-readable storage medium, configured with instructions executable by one or more processors to cause the one or more processors to perform operations comprising: acquiring, by a first terminal associated with a first account, a purchase agreement element packet released by a merchant system; signing, based on the purchase agreement element packet, a purchase agreement by the first terminal with the merchant system; enabling, by the first terminal, the first account to join a blockchain; sending, from the first terminal, an invitation message to other terminals for at least one other account to join the blockchain according to the invitation message; and storing purchase records of the first account and the at least one other account in the blockchain for determining, according to the purchase records in the blockchain, performance of the purchase agreement.

The implementation mode in the present application enables a user to complete a purchase agreement which cannot be performed due to high difficulty and oversupplied resources, and improve matching efficiency between the merchant and the user involved in the purchase agreement, and propagation efficiency of the purchase agreement element packet.

Many technical characteristics are stated in the description and they are distributed in different technical solutions. Listing all possible combinations of technical characteristics, namely, all technical solutions will make the description too long. To avoid the problem, all technical characteristics disclosed in the summary of the invention, all technical characteristics disclosed in the implementation modes and examples below, and all technical characteristics disclosed in the drawings may be freely combined to form different new technical solutions (these new technical solutions may all be considered stated in the description), unless the combinations of technical characteristics are technically infeasible. For example, characteristics A, B and C are disclosed in one example, and characteristics A, B, D and E are disclosed in another example. Characteristics C and D are equivalent technical means which have the same function. Technically, either of characteristics C and D can be selected, and it is impossible to select both of characteristics C and D. Characteristic E can be combined with characteristic C, and then the technical solution formed by combining characteristics A, B, C and D may not be considered stated because of infeasibility. The technical solution formed by combining characteristics A, B, C and E may be considered stated, however.

### BRIEF DESCRIPTION OF THE DRAWINGS

FIG. 1 illustrates a flowchart of a purchase agreement processing method according to one embodiment of the present application.

FIG. 2 illustrates a schematic diagram of an application example, according to one embodiment of the present application.

FIG. 3 illustrates a block diagram of a purchase agreement processing system according to one embodiment of the present application.

### DETAILED DESCRIPTION OF THE EMBODIMENTS

In order to let the reader better understand the present application, many technical details are presented in the description below. However, those skilled in the art can understand that the technical solution required to be protected in the present application can also be implemented without these technical details or various changes and modifications to the following implementation modes.

As used herein, a “credit standard value” is a value used to measure the credit reliability between users. Different credit standard values may correspond to the agreement performance rate of users at different limit risks. The higher the credit standard value is, the higher the creditability of the credit guaranty is.

As used herein, a “credit purchase agreement” means that a user uses his or her own credit as a guaranty to make a purchase agreement with a merchant to acquire rights and interests provided by the merchant after satisfying the requirements in the purchase agreement. It can be used to replace the pre-deposit or prepayment mode in the current commercial society.

As used herein, a “pre-deposit or prepayment” is a mode in which a currency is used as a guaranty in a commercial scenario, and it is used to get an activation of a service or rights and interests of a high-level service in return.

As used herein, a “credit society blockchain” is a credit blockchain formed by a user through the social relationship. After the credit blockchain is formed, the user may obtain a new credit standard value to evaluate and share rights and interests.

As used herein, a “server” is a computer system which may provide service for other equipment in a network. The objects which the server serves are usually called terminals or clients, and the communication connections between the server and terminals can be implemented in wireless or wired mode. The server may be implemented in many ways, and it can be a single computer device, or a combination of a plurality of computer devices (e.g., a cluster server or cloud server). The server may be called a server end or cloud in some application scenarios.

As used herein, a “terminal,” also known as “terminal equipment”, is located at the outmost side in a computer network or communication network, and is mainly used to input user information and output the processing results. Besides input or output functions, a terminal is also capable of performing operations and processing to realize a part of system functions. A terminal may be, for example, a smart phone, tablet, notebook, desktop computer, smart watch, smart bracelet, TV, projector having the input function, or personal digital assistant (PDA).

The implementation modes in the present applications are further described in detail in combination with the drawings.

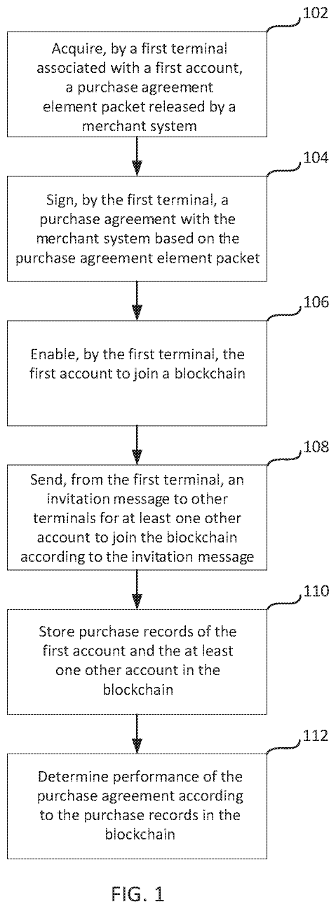

In some embodiments, an implementation mode in the present application relates to a purchase agreement processing method. The method is shown in FIG. 1, including the following steps.

At step 102, a first terminal associated with a first account may acquire a purchase agreement element packet released by a merchant system.

At step 104, the method may include signing, based on the purchase agreement element packet, a purchase agreement between the first terminal and the merchant system. In one embodiment, this step further comprises the merchant system querying a credit standard value of the first account. The first terminal may sign the purchase agreement with the merchant system if the credit standard value satisfies agreed terms (e.g., a sesame credit score exceeds an agreed threshold), and may otherwise reject the merchant system. In one embodiment, the credit standard value of the first account is used as a guaranty when the purchase agreement is signed.

At step 106, the first terminal, through interactions with a server, may enable the first account to join a blockchain. In one embodiment, the blockchain is a private blockchain. The merchant system and the terminals of the first account and other accounts that joined the blockchain may be configured to access the data in the private blockchain, and unrelated terminals may not have rights to access the data in the private blockchain. In one embodiment, the blockchain joined by the first account may be a blockchain created for the purchase agreement, and information of the purchase agreement element packet and the first account is recorded in a first block of the blockchain. The data may be more secure and the query efficiency is higher after a blockchain is separately created for a purchase agreement. In one embodiment, the blockchain joined by the first account is an existing blockchain in which related information about a plurality of purchase agreements may be stored.

At step 108, the first terminal may send an invitation message to other terminals for at least one other account to join the blockchain according to the invitation message. Other terminals may refer to terminals other than the first terminal, and these terminals may be used by the accounts other than the first account.

At step 110, the system may store purchase records of the first account and the at least one other account in the blockchain for determining, according to the purchase records in the blockchain, performance of the purchase agreement. In one embodiment, the purchase records of the first account and the at least one other account are recorded in a distributed ledger in the blockchain, and the merchant system, the first terminal and the terminals of the other accounts are configured to query data in the blockchain.

At step 112, the system may determine performance of the purchase agreement according to the purchase records in the blockchain. In one embodiment, the system may generate statistics for the purchase records in the blockchain, and may determine that the agreement is performed if the statistics satisfies the requirements in the purchase agreement, and that there is a breach of the purchase agreement if the statistics fails to satisfy the requirements in the purchase agreement.

After it is determined that the agreement is performed or that there is a breach of the purchase agreement, the processing mode may vary. In some embodiments, after it is determined that the agreement is performed, the credit standard value of the first account may be increased. After it is determined that there is a breach of the purchase agreement, the first account may refund the agreed rights and interests to the merchant system. In some embodiments, after it is determined that there is a breach of the purchase agreement, the credit standard value of the first account may be reduced if the first account fails to refund the agreed rights and interests to the merchant system within an agreed time limit.

The moment of the performance of step 112 may vary. In some embodiments, step 112 may be performed periodically (e.g., daily or weekly). In some embodiments, step 112 may be performed at a time specified by the merchant system. In some embodiments, step 112 may be performed in response to the instruction of the merchant system.

The blockchain technology may be used in the present implementation mode of the present application so that a user can complete a purchase agreement which cannot be performed due to high difficulty and oversupplied resources, and improve matching efficiency between a merchant and a user in a purchase agreement, and propagation efficiency of a purchase agreement element packet. In addition, the purchase records cannot be altered, which provides a reliable foundation for changing a credit standard value.

To better understand the technical solution in the description, the following gives an example to describe the technical solution. Instead of restricting the scope of protection of the present application, details enumerated in the example may help you to understand the technical solution.

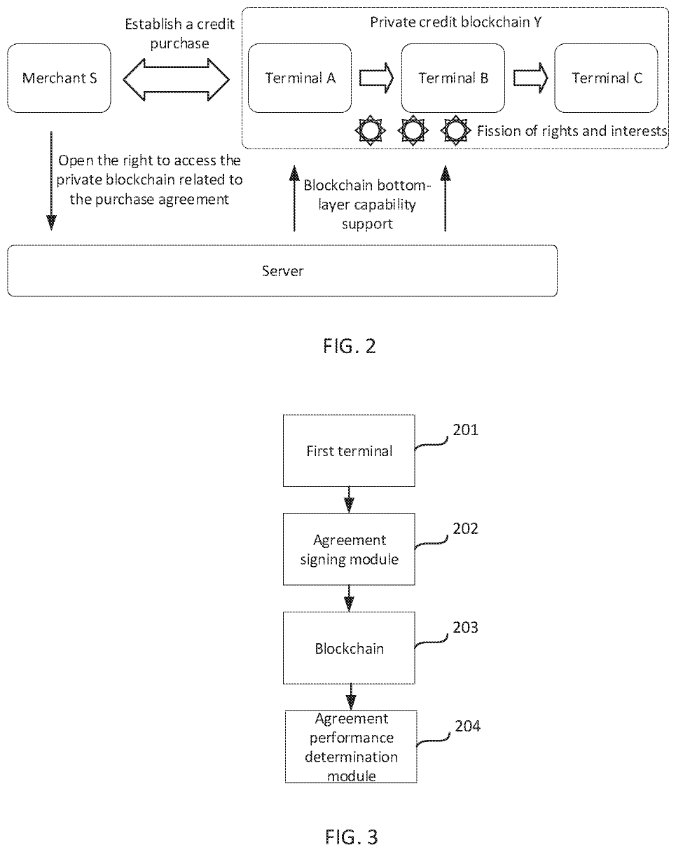

Referring now to FIG. 2, FIG. 2 illustrates a specific application example, wherein merchant S represents a merchant system, terminal A is a terminal (i.e., first terminal) of account A, terminal B is a terminal of account B, and terminal C is a terminal of account C. The server is used to realize the blockchain and other system functions.

When using the merchant system S to release a credit purchase agreement template (i.e., a purchase agreement element packet), a merchant can create its own private blockchain corresponding to the whole purchase agreement through a technical function and by opening system rights that allow the merchant to create a private block.

The merchant system S may broadcast its purchase agreement template and invites users to match with it and sign an agreement. The terminal (i.e., the first terminal) of account A may discover the credit purchase agreement template provided by the merchant system S, and account A may sign the agreement to match with the merchant using the credit value as a guaranty.

Account A may establish its own credit society blockchain Y, act as a seed user through a technical means (including but not limited to information communication means such as Internet, Internet of things, Bluetooth matching and acoustic wave) to make a second broadcast, and invites other accounts to join the blockchain. In some embodiments, account B and account C may receive, through their terminals, the invitation from the first terminal and join the credit society blockchain Y initiated by account A. All purchase records of account A, account B and account C in the merchant may be saved and recorded through the blockchain. Account A may be the root node of the whole blockchain. The purchase agreement element packet, the information of account A and the first purchase record may be recorded in the genesis block (first block) of the blockchain.

All the purchases of accounts A, B and C may be recorded in the blockchain Y, and the merchant's standards for the appraisal and verification of a purchase agreement may be subject to the purchase records in the whole blockchain Y. If the purchases in the whole blockchain satisfy the agreed purchase requirements of the merchant, it is determined that the agreement is performed. Since account A may use its own credit value as a guaranty, the credit value of account A may be increased subsequently. If the purchases in the whole blockchain fail to satisfy the agreed purchase requirements of the merchant, it is determined that there is a breach of the purchase agreement. Under such situations, account A may need to refund the favored rights and interests subsequently, and if account A fails to refund the favored rights and interests within an agreed time limit, the credit value of account A may be reduced.

In some embodiments, account B and account C that join the private blockchain Y may enjoy the rights and interests stipulated in the purchase agreement, and their purchases may be accumulated in the blockchain Y. Since account B and C do not use their credit values as a guaranty, their original credit values may not change, regardless of whether the agreement is performed or breached. Account A may claim any damage from user B or user C according to the unalterable purchase records in the blockchain Y.

Referring now to FIG. 3, FIG. 3 illustrates a block diagram of the purchase agreement processing system. The purchase agreement processing system may include a first terminal 201, an agreement signing module 202, a blockchain 203, an agreement performance determination module 204.

A first terminal 201 associated with a first account, may be configured to acquire a purchase agreement element packet released by a merchant system, enable the first account to join a blockchain through interactions with a server, and send a message to invite at least one other account to join the blockchain.

An agreement signing module 202 may be configured to complete the signing of a purchase agreement by the first terminal with the merchant system based on the purchase agreement element packet. In one embodiment, the agreement signing module 202 may further comprise: a query sub-module, configured to query a credit standard value of the first account, a determination sub-module, configured to determine whether the credit standard value satisfies the agreed terms (e.g., a sesame credit score exceeds an agreed threshold), and a signing sub-module, configured to complete the signing of the purchase agreement between the first terminal and the merchant system when the determination sub-module determines that the credit standard value satisfies the agreed terms. In one embodiment, the credit standard value of the first account is used as a guaranty when the purchase agreement is signed.

A blockchain 203 may be configured to store the purchase records of the first account and the at least one other account. In one embodiment, the blockchain is a private blockchain. The merchant system and the terminals of the first account and other accounts that join the blockchain may be configured to access the data in the private blockchain, and unrelated terminals may have no rights to access the data in the private blockchain. In one embodiment, the purchase records of the first account and the other accounts may be recorded in a distributed ledger in the blockchain, and the merchant system, the first terminal and the terminals of the other accounts may be configured to query data in the blockchain. In one embodiment, information of the purchase agreement element packet and the first account may be recorded in a first block of the blockchain.

An agreement performance determination module 204 may be configured to determine performance of the purchase agreement according to the purchase records in the blockchain. In one embodiment, statistics for the purchase records in the blockchain is generated, and it is determined that the agreement is performed if the statistics satisfies the requirements in the purchase agreement and that there is a breach of the purchased agreement if the statistics fails to satisfy the requirements in the purchase agreement. In some embodiments, after it is determined that the agreement is performed, the credit standard value of the first account may be increased. After it is determined that there is a breach of the purchase agreement, a message for a refund of the agreed rights and interests may be sent to the first account. In some embodiments, the credit standard value of the first account may be reduced if the first account fails to refund the agreed rights and interests to the merchant system within an agreed time limit.

The above-mentioned implementation mode may correspond to the mode of implementing the method of the present implementation mode. Technical details in the above-mentioned implementation mode may be applied to the present implementation mode, and the technical details in the present implementation mode may also be applied to the above-mentioned implementation mode of the present application.

Those skilled in the art can understand the functions realized by the modules of the purchase agreement processing system by reference to the related description of the purchase agreement processing method. The functions of the modules of the purchase agreement processing system can be realized by programs (executable instructions) running on a processor, or can be realized by specific logic circuits. The purchase agreement processing system can be stored in a computer-readable storage medium if it is realized in the form of software functional modules and is marketed or used as an independent product. The technical solution provided in the embodiments of the specification or the part of the technical solution which has made contributions to the prior art can be essentially embodied in the form of a software product. The computer software product is stored in a storage medium and comprises a plurality of instructions which enable a computer device (a PC, server or network device) to execute all or part of the method described in the embodiments of the specification. The above-mentioned storage medium includes USB disk, mobile hard disk, read-only memory (ROM), magnetic disk or optical disk and other media which can store program codes. In this way, the embodiments of the specification are not limited to any specific combination of hardware and software.

Accordingly, the implementation modes of the specification may further provide a computer-readable storage medium, in which computer-executable instructions are stored. The computer-executable instructions are executed by one or more processors, and the method in the present application is realized. The computer-readable storage medium may include volatile or nonvolatile medium, or mobile or immobile medium, and it can realize information storage by use of any method or technique. Information can be computer-readable instructions, data structures, modules of a program or other data. Examples of the storage medium of a computer include but are not limited to phase-change RAM (PRAM), static random access memory (SRAM), dynamic random access memory (DRAM), other types of random access memory (RAM), read-only memory (ROM), electrically erasable programmable read-only memory (EEPROM), flash memory or other memory techniques, compact disk read-only memory (CD-ROM), digital versatile disk (DVD), cassette tape, magnetic tape, magnetic disk or other storage device or any other non-transmission medium, and they can be used to store information which can be accessed by a computer device. According to the definition in this document, computer-readable storage media exclude transitory media, for example, modulated data signals and carriers.

In addition, the implementation modes of the specification may further provide a purchase agreement processing system, which comprises a memory used to store computer-executable instructions and a processor used to realize the steps of the purchase agreement processing method when executing the computer-executable instructions in the memory. The processor can be a central processing unit (CPU), a general processor, a digital signal processor (DSP), or an application specific integrated circuit (ASIC). The memory can be a read-only memory (ROM), random access memory (RAM), flash, hard disk or solid state disk. The steps of the method disclosed in the implementation mode of the specification can directly be performed by a hardware processor or by the combination of hardware and software modules in the processor.

The terms such as first and second in the present application are only used to distinguish one entity or operation from another entity or operation, but do not require or imply any practical relationship or sequence between the entities or operations. In addition, the terms “comprise” and “include” and their variants are intended to cover non-exclusive inclusions so that the process, method, article or device comprising a series of elements not only comprises these elements, but also comprises other elements not listed clearly, or comprises the elements intrinsic to the process, method, article or device. Without any more restrictions, the element defined by “comprising one . . . ” do not exclude the case that other identical elements exist in the process, method, article or device which comprises the element. In the present application, if performing an action according to an element is mentioned, it means that the action is performed at least according to the element. It covers two cases: the action is performed only according to the element and the action is performed according to the element and other elements. “A plurality of” represents two or more.

All documents mentioned in the present application are considered included in the specification of the present application as a whole so that they can provide a basis for any modification, if necessary. In addition, the embodiments described above are only preferred embodiments of the specification, but are not used to limit the scope of protection scope of the specification. Any modification, equivalent replacement, and improvement within the spirit and principle of one or more embodiments of the specification may fall within the scope of protection of one or more embodiments of the specification.

Specific embodiments of the specification are described above. Other embodiments falling within the scope of the claims exist. In some cases, actions or steps stated in the claims can be performed in a sequence different from those described in the embodiments and the expected results can be obtained. In addition, it is unnecessary to show a specific sequence or continuous sequence for the process depicted in the drawings to achieve the expected result. In some implementation modes, multi-task processing and concurrent processing can also be allowed or may be favorable.

What is claimed is:

1. A purchase agreement processing method, comprising:
acquiring, by a first terminal associated with a first account, a purchase agreement element packet released by a merchant system;
signing, based on the purchase agreement element packet, a purchase agreement between the first terminal and the merchant system;
enabling, by the first terminal, the first account to join a blockchain;
sending, from the first terminal, an invitation message to other terminals for at least one other account to join the blockchain according to the invitation message; and
storing purchase records of the first account and the at least one other account in the blockchain for determining, according to the purchase records in the blockchain, performance of the purchase agreement.

2. The method according to claim 1, wherein the signing, based on the purchase agreement element packet, a purchase agreement between the first terminal and the merchant system further comprises:
querying, by the merchant system, a credit standard value of the first account,
signing, if the credit standard value satisfies agreed terms, the purchase agreement by the merchant system with the first terminal, and
rejecting, if the credit standard value does not satisfy the agreed terms, the first terminal.

3. The method according to claim 2, wherein the credit standard value of the first account is used as a guaranty when the purchase agreement is signed.

4. The method according to claim 1, wherein the blockchain is a private blockchain.

5. The method according to claim 4, wherein:
the purchase records of the first account and the at least one other account are recorded in a distributed ledger in the blockchain, and
the merchant system, the first terminal, and terminals of the at least one other account are configured to query data in the blockchain.

6. The method according to claim 1, wherein information of the purchase agreement element packet and the first account is recorded in a first block of the blockchain.

7. The method according to claim 1, wherein the determining performance of the purchase agreement further comprises:
generating statistics for the purchase records in the blockchain,
if the statistics satisfies requirements in the purchase agreement, determining that the purchase agreement is performed, and
if the statistics fails to satisfy the requirements in the purchase agreement, determining that there is a breach of the purchase agreement.

8. The method according to claim 7, further comprising: increasing, in response to determining that the purchase agreement is performed, the credit standard value of the first account.

9. The method according to claim 7, further comprising: refunding, in response to determining that there is a breach of the purchase agreement, agreed rights and interests to the merchant system from the first account.

10. The method according to claim 9, further comprising: reducing, in response to determining that there is a breach of the purchase agreement, the credit standard value of the first account if the first account fails to refund the agreed rights and interests to the merchant system within an agreed time limit.

11. A purchase agreement processing system, comprising:
one or more processors, and
a memory storing instructions executable by the one or more processors to cause the system to perform:
acquiring, by a first terminal associated with a first account, a purchase agreement element packet released by a merchant system;
signing, based on the purchase agreement element packet, a purchase agreement between the first terminal and the merchant system;
enabling, by the first terminal, the first account to join a blockchain;
sending, from the first terminal, an invitation message to other terminals for at least one other account to join the blockchain according to the invitation message; and
storing purchase records of the first account and the at least one other account in the blockchain for determining, according to the purchase records in the blockchain, performance of the purchase agreement.

12. The system according to claim 11, wherein the signing, based on the purchase agreement element packet, a purchase agreement between the first terminal and the merchant system further comprises:
querying a credit standard value of the first account;
determining whether the credit standard value satisfies the agreed terms;
signing the purchase agreement with the first terminal with the merchant system in response to determining that the credit standard value satisfies the agreed terms.

13. The system according to claim 12, wherein the credit standard value of the first account is used as a guaranty when the purchase agreement is signed.

14. The system according to claim 11, wherein the blockchain is a private blockchain.

15. The system according to claim 14, wherein
the purchase records of the first account and the at least one other account are recorded in a distributed ledger in the blockchain, and
the merchant system, the first terminal and terminals of the at least one other account is configured to query data in the blockchain.

16. The system according to claim 11, wherein the determining, according to the purchase records in the blockchain, performance of the purchase agreement further comprises: generating statistics for the purchase records in the blockchain, determining that the purchase agreement is performed if the statistics satisfies requirements in the purchase agreement, and determining that there is a breach of the purchase agreement if the statistics fails to satisfy the requirements in the purchase agreement.

17. The system according to claim 16, wherein the determining, according to the purchase records in the blockchain, performance of the purchase agreement further comprises: increasing, in response to determining that the purchase agreement is performed, the credit standard value of the first account.

18. The system as claimed in claim 16, wherein the determining, according to the purchase records in the blockchain, performance of the purchase agreement further comprises: refunding, in response to determining that there is a breach of the purchase agreement, agreed rights and interests to the merchant system.

19. The system as claimed in claim 18, wherein the determining, according to the purchase records in the blockchain, performance of the purchase agreement further comprises: reducing, in response to determining that there is a breach of the purchase agreement, the credit standard value of the first account if the first account fails to refund the agreed rights and interests to the merchant system.

20. A non-transitory computer-readable storage medium configured with instructions executable by one or more processors to cause the one or more processors to perform operations comprising:
acquiring, by a first terminal associated with a first account, a purchase agreement element packet released by a merchant system;
signing, based on the purchase agreement element packet, a purchase agreement by the first terminal with the merchant system;
enabling, by the first terminal, the first account to join a blockchain;
sending, from the first terminal, an invitation message to other terminals for at least one other account to join the blockchain according to the invitation message; and
storing purchase records of the first account and the at least one other account in the blockchain for determining, according to the purchase records in the blockchain, performance of the purchase agreement.
